(19) United States
(12) Patent Application Publication
(10) Pub. No.: US 2024/0355513 A1
(43) Pub. Date: Oct. 24, 2024

(54) SINTERED RARE-EARTH MAGNET AND METHOD OF MANUFACTURE

(71) Applicant: Shin-Etsu Chemical Co., Ltd., Tokyo (JP)

(72) Inventors: Koichi HIROTA, Echizen-shi (JP); Hiroshi BABA, Echizen-shi (JP); Akihiro YOSHINARI, Echizen-shi (JP)

(73) Assignee: Shin-Etsu Chemical Co., Ltd., Tokyo (JP)

(21) Appl. No.: 18/615,143

(22) Filed: Mar. 25, 2024

(30) Foreign Application Priority Data
Apr. 20, 2023 (JP) 2023-069056

(51) Int. Cl. H01F 1/053; H01F 41/02

(52) U.S. Cl. CPC H01F 1/0536; H01F 41/0266

(57) ABSTRACT

A sintered rare-earth magnet contains specific amounts of R (two or more rare-earth elements, with Nd and Pr being essential), boron (B), M1 (one or more element selected from Al, Si, Cr, Mn, Cu, Zn, Ga, Ge, Mo, Sn, W, Pb and Bi) and M2 (one or more element selected from Ti, V, Zr, Nb, Hf and Ta), with the balance being T (one or more element selected from Fe and Co). The magnet has a R₂Ti₄B main phase and, over an area fraction of more than 0% and up to 10%, an R₂(T, M1)₁₇ phase covered with an R₆(T, M1)₁₄ phase and an R-rich phase. Two magnetization inflection points—a first knickpoint on a low magnetic field side and a second knickpoint on a high magnetic field side—are present in the second quadrant of the magnetic polarization curve at 23° C.

### CROSS-REFERENCE TO RELATED APPLICATIONS

This non-provisional application claims priority under 35 U.S.C. § 119(a) on Patent Application No. 2023-069056 filed in Japan on Apr. 20, 2023, the entire contents of which are hereby incorporated by reference.

### TECHNICAL FIELD

The present invention relates to a sintered rare-earth magnet which has excellent magnetic properties in high-temperature environments. The invention further relates to a method for manufacturing such a magnet.

### BACKGROUND ART

The range of use and production volume of sintered R-T-B rare-earth magnets, as functional materials necessary and indispensable to energy conservation and higher functionality, are growing year by year. Typical applications include motors used in electric and hybrid vehicles, and motors for various home appliances such as air conditioners. The high coercivity of sintered R-T-B rare-earth magnets is an advantage in such applications, but further improvement in heat resistance, that is, further improvement in the magnetic properties, is desired.

In the development of sintered R-T-B rare-earth magnets to date, given that improvements in room-temperature magnetic properties and, in particular, improvements in squareness, influence the real demagnetization behavior in application products, numerous investigations aimed at improving the high-temperature magnetic properties of such magnet products have been carried out. Particularly in the case of sintered R-T-B rare-earth magnets having an elemental composition in which the amount of boron included is low, worsening of the squareness is pronounced. To remedy this, WO 2022/209466 A1 discloses a method which carries out two-stage sintering treatment that prolongs the sintering time.

However, the sintering conditions in the foregoing art are a first sintering time of up to 2 hours and a second sintering time of up to 15 hours. When combined with a cooling time between the first and second sintering treatments, the time required for the sintering step becomes very long. Not only does this lower the productivity, electric power consumption in the sintering step also rises, greatly increasing production costs. In addition, the environmental impact associated with increased carbon dioxide emissions is also a concern.

### SUMMARY OF THE INVENTION

It is therefore an object of the present invention to provide a sintered R-T-B rare-earth magnet which, through optimization of the composition and microstructure within the magnet, exhibits excellent magnetic properties of practical utility in high-temperature environments while holding down the electric power consumption required in the production process.

As a result of intensive investigations, we have discovered that a sintered rare-earth magnet of a given composition, by having a main phase that is a R2T14B phase and including as a grain boundary phase a R₂(T, M1)₁₇ phase covered by a R₆(T, M1)₁₄ phase and an R-rich phase, exhibits a demagnetization curve having two magnetization inflection points at room temperature (23° C.), and that, because magnetization inflection point temperature changes on the low magnetic field side are small, during actual use the magnet is not influenced by the magnetization inflection points and shows a good heat resistance.

Accordingly, in a first aspect, the invention provides a sintered rare-earth magnet which includes R (wherein R is two or more elements selected from rare-earth elements, with Nd and Pr being essential), T (wherein T is one or more element selected from Fe and Co), boron (B), M1 (wherein M1 is one or more element selected from Al, Si, Cr, Mn, Cu, Zn, Ga, Ge, Mo, Sn, W, Pb and Bi) and M2 (wherein M2 is one or more element selected from Ti, V, Zr, Nb, Hf and Ta), with R accounting for 12.5 to 16.0 at %, B for 4.5 to 5.3 at %, M1 for 0.5 to 2.5 at %, M2 for 0.05 to 0.5 at % and the balance being T. The magnet has a R₂T₁₄B main phase and, over an area fraction of more than 0% and up to 10%, an R₂(T, M1)₁₇ phase covered with an R₆(T, M1)₁₄ phase and an R-rich phase. The magnet has present, in a second quadrant of a magnetic polarization curve at 23° C. thereof, two magnetization inflection points—a first knickpoint on a low magnetic field side and a second knickpoint on a high magnetic field side.

In a preferred embodiment of the sintered rare-earth magnet of the invention, the magnetic field at the first knickpoint (first knick field Hₖ₁) is 10 kOe or more.

In another preferred embodiment of the inventive magnet, the absolute value |β₁| of the temperature change rate of the first knick field Hₖ₁ is smaller than the absolute value |β₂| of the temperature change rate of the magnetic field at the second knickpoint (second knick field Hₖ₂) and satisfies formula (1) below

$$\vert {β}_{1} \vert < \vert {β}_{2} \vert \times 0.94 , \qquad ( 1 )$$

the temperature change rate β₁ of the first knick field Hk1 and the temperature change rate β₂ of the second knick field Hk2 being defined as follows:

$$\begin{matrix}{β}_{1} = ( {H}_{k 1} @ 90 ° C . - {H}_{k 1} @ 23 ° C . ) / ( 90 - 23 ) / ( {H}_{k 1} @ 23 ° C . ) \\ {β}_{2} = ( {H}_{k 2} @ 90 ° C . - {H}_{k 2} @ 23 ° C . ) / ( 90 - 23 ) / ( {H}_{k 2} @ 23 ° C . ) .\end{matrix}$$

In yet another preferred embodiment, in at least the second quadrant of magnetic polarization curves at 90° C. and above, the first knickpoint vanishes.

In still another preferred embodiment, in the second quadrant of magnetic polarization curves at a temperature range above 23° C. and below 90° C., the first knick field Hₖ₁ is 8 kOe or more.

In a further preferred embodiment, in the magnetic polarization curve at 23° C., an average relative permeability μ₂ between the first knick field Hₖ₁ and the second knick field Hₖ₂ is larger than 1.1 and smaller than 1.3.

In a still further preferred embodiment, in a magnetic polarization curve at any temperature, an average relative permeability μ₁ at a magnetic field lower than the first knick field Hₖ₁ is at least 1.0 and not more than 1.05.

In a second aspect, the invention provides a method for producing the sintered rare-earth magnet of claim 1, which method includes a heat treatment step that sinters a green compact obtained by pressing a fine alloy powder within a magnetic field, in which treatment step the sintering temperature T is at least 1,020° C. and not more than 1,080° C. and the sintering time t, given by formula (2) below

$$t = 200.45 \pm 1 - 0.185 T , \qquad ( 2 )$$

is 1 hour or more and less than 11 hours.

### Advantageous Effects of the Invention

This invention enables sintered rare-earth magnets having excellent magnetic properties in high-temperature environments to be obtained at a good productivity.

### BRIEF DESCRIPTION OF THE DRAWINGS

FIG. 1 is a graph showing magnetic polarization curves at from 23° C. to 140° C. for the sintered rare-earth magnet obtained in Example 1.

FIG. 2 is a graph obtained by plotting, for the same sintered rare-earth magnet, changes in the second-order derivative of magnetization with respect to the magnetic field, and describing downwardly convex peak values as Hₖ₂.

FIG. 3 is a graph obtained by enlarging FIG. 2 and similarly determining Hₖ₁.

FIG. 4 is a photograph showing a backscattered electron compositional image of a section parallel to the direction of magnetization for the sintered magnet after low-temperature heat treatment in Example 1.

### DETAILED DESCRIPTION OF THE INVENTION

The composition, microstructure and magnetic properties of the highly heat-resistant sintered rare-earth magnetic of the invention and the method for manufacturing such a magnet according to the invention are described in detail below. The objects, features and advantages of the invention will become more apparent from this description taken in conjunction with the appended diagrams.

The sintered rare-earth magnet of the invention has an elemental composition in which R elements account for 12.5 to 16.0 at %, boron (B) for 4.5 to 5.3 at %, M1 elements for 0.5 to 2.5 at % and M2 elements for 0.05 to 0.5 at %, with the balance being T.

R is two or more elements selected from rare-earth elements, with Nd and Pr being essential. The rare-earth elements other than Nd and Pr are preferably Y, La, Ce, Gd, Tb, Dy and Ho. The content of R with respect to the overall composition, excluding unavoidable impurities in the magnet, is from 12.5 at % to 16.0 at %, and preferably 13 at % or more. The upper limit is 16 at % or less. At an R content below 12.5 at %, the coercivity of the magnet decreases radically; at above 16 at %, the residual flux density Bᵣ decreases. The essential constituents Nd and Pr together account for preferably from 80 to 100 at % of R overall. Dy, Tb and Ho may or may not be included in R. If they are included, the content thereof, expressed as the sum of Dy, Tb and Ho, is preferably 5 at % or less, more preferably 4 at % or less, even more preferably 2 at % or less, and still more preferably 1.5 at % or less, of R overall.

M1 is one or more element selected from Al, Si, Cr, Mn, Cu, Zn, Ga, Ge, Mo, Sn, W, Pb and Bi. M1 is an element that is needed to form the subsequently described R₆(T, M1)₁₄ phase; addition in a given amount enables this phase to be formed. In cases where M1 is not included, a R₆(T, M1)₁₄ phase does not form and the subsequently described magnetic properties particular to this invention cannot be obtained. The content of M1 with respect to the overall composition, excluding unavoidable impurities in the magnet, is from 0.5 at % to 2.5 at %, with the lower limit being preferably 1.0 at % or more. At an M1 content below 0.5 at %, the amount of R₆(T, M1)₁₄ phase precipitation in the grain boundary phase is low and sufficient magnetic properties do not appear. On the other hand, at an M1 content greater than 2.5 at %, the residual flux density Bᵣ decreases, which is undesirable.

M2 is one or more element selected from Ti, V, Zr, Nb, Hf and Ta. The content of M2 is from 0.05 at % to 0.5 at %. Within this content range, by forming compounds with boron and carbon during sintering, M2 is effective for suppressing abnormal grain growth and reducing the variability of magnetic properties due to compositional fluctuations.

The boron content with respect to the overall composition, excluding unavoidable impurities in the magnet, is from 4.5 at % to 5.3 at %. As mentioned above, boron forms compounds with some of the M2 elements, and so the amount of boron added is adjusted within the range of 4.5 at % to 5.3 at % according to the amount of M2 added.

T is one or more element selected from Fe and Co. T accounts for the balance of the overall composition, excluding unavoidable impurities in the magnet. The T content is preferably 70 at % or more, and more preferably 75 at % or more, and is preferably 85 at % or less, and more preferably 80 at % or less.

T may include Co for the purpose of improving the Curie temperature and the corrosion resistance. The content thereof with respect to the overall composition, excluding unavoidable impurities, is preferably 10 at % or less, and more preferably 5 at % or less. A Co content greater than 10 at % invites a major decrease in coercivity and leads to increased costs.

The sintered rare-earth magnet of the invention may include oxygen and nitrogen. However, because oxygen and nitrogen tend to form complex compounds that contain carbon, the contents thereof are preferably low. The contents of these elements with respect to the overall composition, excluding unavoidable impurities, is preferably 1.5 at % or less, and more preferably 1.0 at % or less, for oxygen, and is preferably 0.5 at % or less, and more preferably 0.2 at % or less, for nitrogen.

The sintered rare-earth magnet of the invention may include carbon. The carbon content is preferably 1.0 at % or less. Carbon remains present in the sintered compact as a constituent included as an impurity in the raw materials and also as decomposition residues of lubricant added to enhance the degree of alignment of the fine powder in pressing within a magnetic field. Also, in the sintered compact, carbon dissolves in R oxides or R-rich phases within grain boundary phases. In addition, at the compositional range of boron in this invention, carbon replaces some of the boron in the main phase, forming a R₂T₁₄(B, C)₁ phase. A carbon content suitable for the desired magnetic properties is adjusted according to the boron and M2 element contents.

Aside from these elements, it is allowable also for elements such as H, F, Mg, P, S, Cl and Ca to be included as unavoidable impurities. Expressed in terms of the sum of unavoidable impurities with respect to the sum of the aforementioned constituent elements of the magnet and unavoidable impurities, the presence of up to 0.1 wt % of such unavoidable impurities is allowed, although a lower content is preferred.

From the standpoint of improving the magnetic properties, the grains in the sintered rare-earth magnet of the invention have a mean size of preferably at least 1.5 μm and up to 5 μm. Also, adding a lubricant increases the orientability of the grains when pressing the powder within a magnetic field; the degree of alignment of the c-axis, which is the easy axis of magnetization of the main-phase grains, is preferably set to 98% or more. The residual flux density (Bᵣ) of the sintered rare-earth magnet of the invention is preferably 12 kG (1.2 T) or more at about 23° C., and the coercivity is preferably 20 kOe (1,592 kA/m) or more at about 23° C.

In the sintered rare-earth magnet of the invention, because the above-described boron content is lower than in the stoichiometric composition of R₂Fe₁₄B₁, a ferromagnetic R₂(T, M1)₁₇ phase is formed, and it leads to a decrease in coercivity and worsening of the squareness. However, in the sintered rare-earth magnet of the invention, magnetic interactions between the R₂(T, M1)₁₇ phase and main-phase grains can be decoupled and the propagation of magnetization reversal suppressed by covering the R₂(T, M1)₁₇ phase with a R₆(T, M1)₁₄ phase and an R-rich phase. Increasing this coverage ratio is effective for suppressing magnetization reversal; once the R₂(T, M1)₁₇ phase has become paramagnetic at or above the magnetic phase transition temperature, the magnetic influence decreases, enabling decreased coercivity and worsening of the squareness to be suppressed. Hence, this coverage ratio, although not particularly limited, is preferably 50% or more, and more preferably 70% or more.

The area fraction of the R₂(T, M1)₁₇ phase relative to the surface area of the whole sintered magnet in a sectional image thereof, when small, is effective for suppressing magnetization reversal. However, for reasons similar to those mentioned above, at high temperatures, the magnetic properties are improved and there is no effect in practical use; hence, it is not necessary to have this phase entirely disappear. An area fraction above 10% is undesirable because, even at high temperatures, the influence of on the magnetic properties cannot be ignored in practice. Moreover, although prolonging the sintering time and adding homogenizing treatment are effective for causing this phase to entirely disappear, these process modifications not only lower the productivity, they also lead to higher production costs due to an increase in electric power consumption, which is undesirable. Taking the above into account, the area fraction of the R₂(T, M1)₁₇ phase is more than 0% and up to 10%, with the lower limit value being preferably 3% or more and the upper limit value being preferably 5%.

The sintered rare-earth magnet obtained in the present invention has two magnetization inflection points (knickpoints) in the second quadrant of the magnetic polarization curve at room temperature (23° C.). In this invention, the knickpoint on the higher magnetic field side is referred to as the second knickpoint, and the knickpoint on the lower magnetic field side is referred as the first knickpoint.

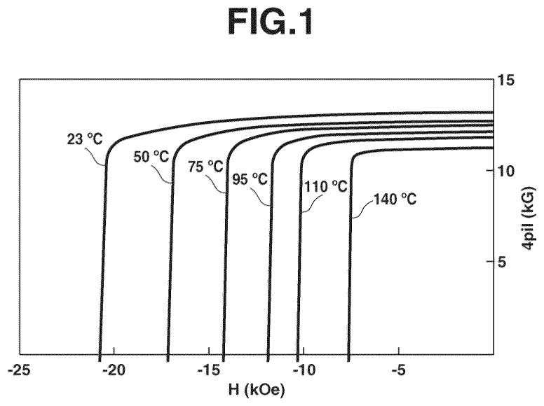

As used herein, “knickpoint” refers to a point on a magnetic polarization curve where the rate of change in magnetic polarization with respect to the magnetic field reaches a local maximum, and the magnetic field that gives this knickpoint, specifically the magnetic field that gives a minimum value for the second order derivative of magnetic polarization with respect to the magnetic field, is referred to as a “knick field.” Referring to FIG. 1 which shows examples of magnetic polarization curves, on the magnetic polarization curve at room temperature (23° C.), the magnetization change rate increases at a magnetic field of 13 to 14 kOe, in addition to which a significant change in magnetization due to magnetization reversal is apparent at about 20 kOe.

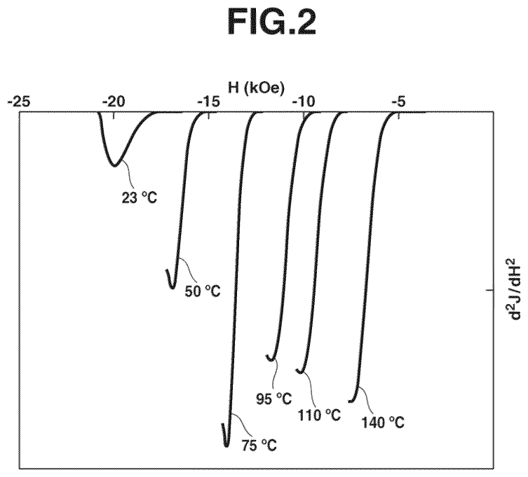

FIG. 2 is a scatter plot of the second order derivatives of the magnetic polarization curves shown in FIG. 1 versus the magnetic field, in which plot can be found downwardly convex curves. The peak around 20 kOe in the curve at room temperature (23° C.) means the magnetic field at which the magnetization change ratio reaches a maximum value due to coherent magnetization reversal of the main-phase grains and is referred to as the “second knick field Hₖ₂.”

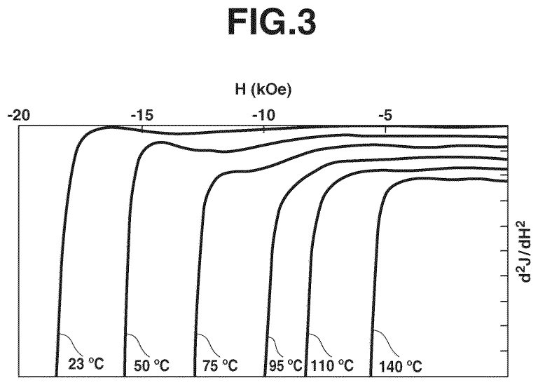

FIG. 3 is an enlarged graph of the vertical axis in FIG. 2. For example, the small peak at a magnetic field of about 13 kOe in the curve at 23° C. represents the magnetization change associated with local magnetization reversals of the ferromagnetic phase which partially remains within the sintered compact microstructure and of the main phase around the ferromagnetic phase. This magnetic field is referred to as the “first knick field Hₖ₁.”

The first knick field at 23° C. for the sintered rare-earth magnet of the invention is preferably 10 kOe or more. At 10 kOe or more, the magnetic flux at the point of operation does not readily decrease and therefore can be suitably used in practice.

The temperature change rate P₁ of the first knick field Hₖ₁ and the temperature change rate β₂ of the second knick field Hₖ₂ are represented by the following formulas. In these formulas, “@23° C.” denotes the value at 23° C.

$$\begin{matrix}{β}_{1} = ( {H}_{k 1} @ 90 ° C . - {H}_{k 1} @ 23 ° C . ) / ( 90 - 23 ) / ( {H}_{k 1} @ 23 ° C . ) \\ {β}_{2} = ( {H}_{k 2} @ 90 ° C . - {H}_{k 2} @ 23 ° C . ) / ( 90 - 23 ) / ( {H}_{k 2} @ 23 ° C . ) .\end{matrix}$$

It is preferable for the absolute value |β₁| of the temperature change rate of the first knick field to be smaller than the absolute value |β₆| of the temperature change rate of the second knick field and for these to satisfy the relationship in formula (1) below

$$\vert {β}_{1} \vert < \vert {β}_{2} \vert \times 0.94 . \qquad ( 1 )$$

That is, the absolute value |β₁| of the temperature change rate of the first knick field Hₖ₁ is preferably more than 6% smaller than the absolute value |β₂| of the temperature change rate of the second knick field Hₖ₂. A value within this range, is desirable because there is hardly any decrease in the magnetic flux at the point of operation in a high-temperature environment.

The first knick field Hₖ₁ is preferably 8 kOe or more at temperatures that are higher than 23° C. and less than 90° C., and the first knickpoint preferably vanishes at 90° C. and above. When the first knick field Hₖ₁ is within this range, the magnetic flux at the point of operation in a high-temperature environment does not readily decrease, which is desirable.

The reason why the first knickpoint which is observable at 23° C. vanishes at 90° C. and above and the microstructural reason why the absolute value |β₁| of the temperature change rate of the first knick field is preferably more than 6% smaller than the absolute value |β₂| of the temperature change rate of the second knick field are not entirely clear. However, these are presumed to be attributable to transitioning of the magnetic phase which remained within the above-mentioned microstructure to the paramagnetic phase and to magnetic decoupling between the ferromagnetic phase and surrounding main-phase grains due to the formation of a R₆(T, M1)₁₄ phase distributed so as to cover the ferromagnetic phase.

In the magnetic polarization curve at 23° C. for the sintered rare-earth magnet of the invention, it is preferable for the average relative permeability (μ₁) at a lower magnetic field than the first knick field Hₖ₁ to be at least 1.0 and not more than 1.05. At the same time, it is preferable for the average relative permeability (μ₂) at a magnetic field between the first knick field (H₁ₖ) and the second knick field (H₂ₖ) to be larger than 1.1 and smaller than 1.3. When μ₁ is 1.05 or less, the magnetic flux at the point of operation does not readily decrease, which is desirable in terms of practical use. When μ₂ is smaller than 1.3, the magnetic flux at the point of operation in a high-temperature environment does not readily decrease, which is desirable. Moreover, when μ₂ is larger than 1.1, an increase the production load and a drop inproductivity can be avoided due to a reduction in excessive inputs of energy and time in the sintering operation, as subsequently described.

Next, a method for manufacturing a sintered rare-earth magnet according to the invention is described. This method, which is a method for manufacturing the above-described sintered rare-earth magnet of the invention, includes a heat treatment step that sinters a compact obtained by pressing a fine alloy powder within a magnetic field. More specifically, the manufacturing method of the invention includes a melting step which melts the raw materials to obtain an alloy containing the respective above-mentioned elements R, T, B, M1 and M2, a milling step which mills the alloy of a predetermined composition so as to obtain a fine powder, a pressing step which presses the fine alloy powder in a magnetic field to form a compact, and a heat treatment step which sinters and homogenizes the compact and then forms the above-described microstructure.

In the melting step, metals serving as the raw materials for the respective elements, or alloys thereof, are weighed out to the above-described predetermined composition in this invention. The raw materials are then melted such as by high-frequency melting and then cooled to produce an alloy. Casting of the alloy is generally carried out by a melt casting process that casts the molded alloy in a flat mold or a book mold or by a strip casting process. Alternatively, in this invention, it is also possible to use the so-called two-alloy process which weighs out and mixes together, after coarse milling, an alloy close in composition to the R₂Fe₁₄B compound that is the main phase of R-T-B-type alloys and, as a sintering aid, a low-melting alloy which melts at the sintering temperature. It is preferable for the sintering aid to include a large amount of R constituents in order to decrease its melting point. The casting process is not particularly specified; aside from those processes mentioned above, use can also be made of a liquid quenching process.

The milling step may be a multi-stage step which includes, according to the form of the raw material to be charged, a coarse milling step and a fine milling step. A jaw crusher, Braun mill, pin mill or hydrogen decrepitation, for example, may be used in the coarse milling step. Industrially, a method that carries out hydrogen decrepitation using a ribbon-shaped alloy obtained by strip casting to give a coarse powder having a mean particle size of from 0.05 to 3 mm, especially 0.05 to 1.5 mm, is suitably employed. After coarse milling, a lubricant may be suitably added in order to increase the orientability of the powder in the pressing step. The lubricant is exemplified by saturated fatty acids such as stearic acid, decanoic acid and lauric acid; saturated fatty acid salts such as zinc stearate; compounds having a polar functional group and a cyclohexane skeleton, such as cyclohexanol, cyclohexylamine, cyclohexanone and cyclohexanecarboxylic acid; and cyclic terpenes having a cyclohexane skeleton within the molecule, such as menthol, menthone and camphor. Combinations of these may also be mixed and added as the lubricant.

In the fine milling step, suitable use can be made of a method which uses a jet mill to mill the above coarse powder under a stream of inert gas such as nitrogen, helium or argon. The mean particle size after milling, expressed as the volume-based median size D50, is preferably from 0.2 μm to 10 μm, and more preferably from 0.5 μm to 5 μm. To lower the impurity oxygen concentration within the sintered compact, the amount of moisture in the atmosphere during milling is preferably set to 100 ppm or less. As used herein, the volume-based median size D50 refers to the particle size when the cumulative volumetric frequency reaches 50%.

In the pressing step, use can be made of a method which obtains a powder compact by, for example, compressing the fine powder while applying a 400 to 1,600 kA/m magnetic field to orient the powder in the direction of the easy axis of magnetization. The density of the compact at this time is set to preferably from 2.8 to 4.2 g/cm³. That is, to ensure the strength of the compact and obtain a good handleability, it is preferable to set the density of the compact to at least 2.8 g/cm³. On the other hand, to keep the alignment of the grains from being disrupted during the application of pressure while achieving sufficient strength as a compact, it is preferable for the density of the compact to be not more than 4.2 g/cm³. Pressing is preferably carried out in an inert gas atmosphere of nitrogen, argon or the like so as to suppress oxidation of the alloy fine powder.

In the heat treatment step, the compact obtained in the pressing step is sintered in a non-oxidizing atmosphere such as a high vacuum or argon gas. The sintering temperature T is in a temperature range of 1,020° C. or more and not more than 1,080° C., and the holding time t is at least 1 hour and less than 11 hours. At a holding time of less than 1 hour, temperature followability in the sintered body is inadequate and so sintering irregularities may arise within the furnace and in the sintered compact. On the other hand, at a holding time of 11 hours or more, the productivity markedly worsens. Within the above holding time range, the preferred holding time is given by formula (2) below, which is a function of the sintered temperature T.

$$t = 200.45 \pm 1 - 0.185 T \qquad ( 2 )$$

By keeping the holding time within this range, a sintered rare-earth magnet of the present invention having the above-described characteristics can be obtained. When the holding time is shorter than the time obtained by formula (2), this leads to a decrease in coercivity and an increase in the average relative permeability μ₂. Conversely, when the holding time is longer, at high temperatures, this leads to a decrease in the strength of the sintered body due to the occurrence of abnormal grain growth and to a worsening of the magnetic properties. On the other hand, at low temperatures, this leads to a drop in productivity and increased costs. After sintering, it is preferable to rapidly cool the compact to 400° C. or below by gas quenching (cooling rate, 20° C./min or more).

Following the above heat treatment for sintering, heat treatment at a lower temperature than this sintering temperature may be carried out for the purpose of increasing the coercivity. This post-sintering heat treatment may be carried out as a two-stage heat treatment consisting of high-temperature heat treatment and low-temperature heat treatment, or may be carried out as only low-temperature heat treatment. In high-temperature heat treatment within this post-sintering heat treatment, the sintered body is preferably heat-treated at a temperature of between 900° C. and 1,000° C.; in low-temperature heat treatment, the sintered body is preferably heat-treated at a temperature of between 400° C. and 600° C. Cooling after high-temperature heat treatment preferably involves rapid cooling to 400° C. or below by gas quenching (cooling rate, 5° C./min or more). On the other hand, the cooling rate following low-temperature heat treatment, although not particularly specified so long as the magnetic properties are not affected, preferably involves rapid cooling to 40° C. or below so as to suppress surface oxidation of the sintered body and discharge it from the furnace in a short time.

### EXAMPLES

The invention is illustrated more fully below by way of Examples and Comparative Examples, although the invention is not limited by these Examples.

### Example 1

An alloy ribbon having an average thickness of about 300 μm was produced by melting starting metals or alloys in a high-frequency melting furnace under an argon gas atmosphere so as to give an alloy composition of Di_{15.0}Fe_{bal}Co_{1.0}B_{5.3}Al_{0.2}Cu_{0.2}Ga_{0.9}Si_{0.2}Zr_{0.2} (wherein Di was a mixture of Nd and Pr in the compositional ratio Nd:Pr=78:22) and strip casting the melt. The alloy ribbon was hydrogenated and then coarsely milled by dehydrogenation treatment, following which 0.15 wt % of stearic acid was added, giving a coarse powder having a mean particle size of about 100 μm. Next, fine milling to a mean particle size of 3 μm or less was carried out with a jet mill under a stream of nitrogen. The oxygen concentration within the jet mill at this time was controlled to 50 ppm or below.

The resulting fine powder was charged into the mold of a powder-compacting press under a nitrogen atmosphere and, while applying a 15 kOe horizontal static magnetic field, was pressed and compacted in a direction perpendicular to the magnetic field in order to orient the powder. The resulting compact was sintered by 5.5 hours of heat treatment in a vacuum at 1,050° C. and subsequently cooled to 200° C. or below. Next, heating at 900° C. was maintained for 2 hours, following which the sintered body was cooled in an argon gas atmosphere at a rate of 20° C./min and then low-temperature heat-treated at 470° C. for 2 hours.

A specimen in the shape of a rectangular parallelepiped having dimensions of 18 mm×15 mm×12 mm was cut from the center portion of the resulting sintered body, and the magnetic properties were measured with a BH tracer from Toei Industry Co., Ltd. The measurement temperatures were room temperature (23° C.), and also 50° C., 75° C., 95° C., 110° C. and 140° C.

FIG. 1 shows magnetic polarization curves at temperatures from 23° C. to 140° C., and Table 1 shows the results of magnetic property measurements. From these, a first knickpoint can be observed at 13.5 kOe in the magnetic polarization curve at 23° C.; at a magnetic field higher than this, magnetization began to decrease, as a result of which worsening of the magnetic field Hₖ and the squareness ratio (Hₖ/H_{cJ}) can be observed. At above 90° C., the first knickpoint has vanished, and so improvements in Hₖ and the squareness ratio can be observed.

TABLE 1

| | Temperature (° C.) | | | | | |
|---|---|---|---|---|---|---|
| | Room | | | | | |
| | temperature | 50 | 75 | 95 | 110 | 140 |
| Br (kG) | 13.16 | 12.68 | 12.46 | 12.13 | 11.81 | 11.26 |
| H_{cJ} (kG) | 20.8 | 17.2 | 14.3 | 11.9 | 10.4 | 7.6 |
| Hₖ (kOe) | 19.2 | 16.4 | 13.7 | 11.5 | 10.1 | 7.5 |
| Hₖ/H_{cJ} | 0.92 | 0.95 | 0.96 | 0.97 | 0.97 | 0.99 |
| Hₖ₁ (kOe) | 13.5 | 11.6 | 10.4 | none | none | none |
| Hₖ₂ (kOe) | 19.9 | 16.9 | 14.0 | 11.6 | 10.1 | 7.5 |

Table 2 shows β₁ and β₂ from 23° C. to 80° C., the average relative permeability (μ₁) in a magnetic field lower than Hₖ₁ and the average relative permeability (μ₂) between Hₖ₁ and Hₖ₂ as calculated from the magnetic polarization curve at 23° C. in FIG. 1.

TABLE 2

| β₁ (%/K) | β₂ (%/K) | μ₁ | μ₂ |
|---|---|---|---|
| −0.422 | −0.575 | 1.02 | 1.17 |

From the results in Table 2, it is apparent that the absolute value |β₁| of the temperature change rate of Hₖ₁ is about 27% smaller than the absolute value |β₂| of the temperature change rate of Hₖ₂. The average permeability was confirmed to differ on either side of the first knickpoint, and the average relative permeability (μ₂) between the first knickpoint and the second knickpoint was found to increasing to 1.17. FIG. 2 shows a graph that plots changes in the second order derivative of magnetization versus the magnetic field. In this graph, the downwardly convex peak values were treated as Hₖ₂. FIG. 3 shows a graph obtained by enlarging FIG. 2 and similarly calculating Hₖ₁.

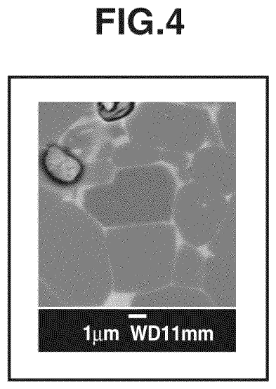

A section of the sintered compact following low-temperature heat treatment was examined with a scanning electron microscope (SEM). FIG. 4 shows a backscattered electron compositional image of a section that is parallel to the direction of magnetization. At the center of this image can be observed a (Nd, Pr)₂(Fe, Co, Ga, Si)₁₇ phase covered with a (Nd, Pr)₆(Fe, Ga, Si, Al)₁₄ phase and an R-rich phase. The area fraction of this phase relative to the overall section was 3%.

### Examples 2 to 4

In each of the examples, an alloy ribbon having an average thickness of about 300 μm was produced by melting starting metals or alloys in a high-frequency melting furnace under an argon gas atmosphere so as to give the alloy composition shown in Table 3 below and strip casting the melt. The alloy ribbon was hydrogenated and then coarsely milled by dehydrogenation treatment, following which 0.15 wt % of stearic acid was added, giving a coarse powder having a mean particle size of about 100 μm. Next, fine milling to a mean particle size of 3 μm or less was carried out with a jet mill under a stream of nitrogen. The oxygen concentration within the jet mill at this time was controlled to 50 ppm or below.

TABLE 3

| | Atomic percent | | | | | | | | | |
|---|---|---|---|---|---|---|---|---|---|---|
| | Nd | Pr | Fe | Co | B | Al | Cu | Ga | Si | Zr |
| Example 2 | 11.7 | 3.3 | balance | 1.0 | 5.3 | 0.2 | 0.5 | 0.5 | 0.3 | 0.2 |
| Example 3 | 11.7 | 3.3 | balance | 1.0 | 5.3 | 0.2 | 0.2 | 0.5 | 0.7 | 0.2 |
| Example 4 | 11.7 | 3.3 | balance | 1.0 | 5.2 | 0.8 | 0.2 | 0.5 | 0.3 | 0.2 |

The resulting fine powder was charged into the mold of a powder-compacting press under a nitrogen atmosphere and, while applying a 15 kOe horizontal static magnetic field, was pressed and compacted in a direction perpendicular to the magnetic field in order to orient the powder. The resulting compact was sintered by 5.5 hours of heat treatment in a vacuum at 1,050° C. and subsequently cooled to 200° C. or below. Next, heating at 900° C. was maintained for 2 hours, following which the sintered body was cooled in an argon gas atmosphere at a rate of 20° C./min and then low-temperature heat-treated at 470° C. for 2 hours.

A specimen in the shape of a rectangular parallelepiped having dimensions of 18 mm×15 mm×12 mm was cut from the center portion of the resulting sintered body, and the magnetic properties were measured with a BH tracer from Toei Industry Co., Ltd. The measurement temperatures were room temperature (23° C.), and also 50° C., 65° C., 70° C., 80° C. and 95° C. The results are shown in Tables 4 and 5. The details are subsequently described.

SEM microscopy was carried out in the same way as in Example 1, whereupon the area fraction of a (Nd, Pr)₂(Fe, Co, Ga, Si)₁₇ phase covered with a (Nd, Pr)₆(Fe, Ga, Si, Al)₁₄ phase and an R-rich phase relative to the overall section was found to be from 3 to 5% in each of the magnets.

### Comparative Example 1

An alloy ribbon having an average thickness of about 500 μm was produced by melting starting metals or alloys in a high-frequency melting furnace under an argon gas atmosphere so as to give an alloy composition of Di_{14.0}Dy_{1.0}Fe_{bal}Co_{1.0}B_{6.2}Al_{0.2}Cu_{0.1}Zr_{0.1} (wherein Di is a mixture of Nd and Pr in the compositional ratio Nd:Pr=78:22) and strip casting the melt. The alloy ribbon was hydrogenated and then coarsely milled by dehydrogenation treatment, following which 0.05 wt % of stearic acid was added, giving a coarse powder having a mean particle size of about 100 μm. Next, fine milling to a mean particle size of 3.5 μm or less was carried out with a jet mill under a stream of nitrogen. The oxygen concentration within the jet mill at this time was controlled to 500 ppm or below.

The resulting fine powder was charged into the mold of a powder-compacting press under a nitrogen atmosphere and, while applying a 15 kOe horizontal static magnetic field, was pressed and compacted in a direction perpendicular to the magnetic field in order to orient the powder. The resulting compact was sintered by 3 hours of heat treatment in a vacuum at 1,100° C. and subsequently cooled to 200° C. or below. Next, heating at 900° C. was maintained for 2 hours, following which the sintered body was annealed in an argon gas atmosphere and then low-temperature heat-treated at 470° C. for 2 hours.

A specimen in the shape of a rectangular parallelepiped having dimensions of 18 mm×15 mm×12 mm was cut from the center portion of the resulting sintered body, and the magnetic properties were measured with a BH tracer from Toei Industry Co., Ltd. The measurement temperatures were room temperature (23° C.), and also 50° C., 65° C., 70° C., 80° C. and 95° C. The results are shown in Tables 4 and 5.

SEM microscopy was carried out in the same way as in Example 1, whereupon precipitation of the (Nd, Pr, Dy)₂(Fe, Co)₁₇ phase in the microstructure of the sintered body due to Fe precipitation in the alloy was observed. However, because the amount of B was large, precipitation of the R₆(T, M1)₁₄ phase was not observed.

TABLE 4

| | Temperature | | | | | | | |
|---|---|---|---|---|---|---|---|---|
| | | | Room | | | | | |
| | Room temperature | | temperature | 50° C. | 65° C. | 70° C. | 80° C. | 95° C. |
| | Magnetic properties | | | | | | | |
| | Bᵣ | H_{cJ} | Hₖ₁ (kOe) (top value) | | | | | |
| | (kG) | (kOe) | Hₖ/H_{cJ} (bottom value) | | | | | |
| Example 2 | 13.15 | 20.1 | 13.4 | 11.3 | 10.4 | none | none | none |
| | | | 0.89 | 0.92 | 0.92 | 0.92 | 0.93 | 0.94 |
| Example 3 | 13.09 | 20.8 | 14.5 | 11.5 | 10.7 | 10.6 | 10.1 | none |
| | | | 0.83 | 0.88 | 0.90 | 0.91 | 0.92 | 0.94 |
| Example 4 | 13.07 | 20.5 | 13.2 | 12.8 | 10.8 | none | none | none |
| | | | 0.94 | 0.95 | 0.95 | 0.95 | 0.96 | 0.96 |
| Comparative | 12.85 | 20.7 | 13.5 | 11.5 | 10.5 | 10.0 | 9.2 | 8.1 |
| Example 1 | | | 0.89 | 0.89 | 0.89 | 0.89 | 0.88 | 0.89 |

TABLE 5

| | β₁ (%/K) | β₂ (%/K) | μ₁ | μ₂ |
|---|---|---|---|---|
| Example 2 | −0.517 | −0.555 | 1.03 | 1.18 |
| Example 3 | −0.527 | −0.597 | 1.02 | 1.26 |
| Example 4 | −0.371 | −0.607 | 1.02 | 1.16 |
| Comparative Example 1 | −0.558 | −0.589 | 1.02 | 1.17 |

As shown in Table 4, in the sintered rare-earth magnets in Examples 2 to 4, at 23° C. a first knickpoint is present and worsening of the squareness is observable, but at 70° C. to 95° C., the first knickpoint has vanished and the squareness has improved. Also, as shown in Table 5, in the sintered rare-earth magnets in Examples 2 to 4, it is apparent that the absolute value |β₁| of the temperature change rate of Hₖ₁ is smaller than the absolute value |β₂| of the temperature change rate of Hₖ₂. Moreover, the average permeability was confirmed to differ on either side of the first knickpoint, the average relative permeability (μ₂) between the first knickpoint and the second knickpoint was found to increase to from 1.16 to 1.26.

On the other hand, in the sintered rare-earth magnet of Comparative Example 1, a first knickpoint was present even at 95° C. and the squareness did not sufficiently improve. The reason is conjectured to be that, as described above, although precipitation of the (Nd, Pr, Dy)₂(Fe, Co)₁₇ phase within the microstructure of the sintered body, which occurred because of Fe precipitation in the alloy, was observed, the R₆(T, M1)₁₄ phase did not precipitate out due to the large amount of B and magnetically coupled with the main phase.

### Examples 5 and 6, Comparative Examples 2 to 6

In each of these examples, an alloy ribbon having an average thickness of about 300 μm was produced by melting starting metals or alloys in a high-frequency melting furnace under an argon gas atmosphere so as to give an alloy composition of Di_{15.0}Fe_{bal}Co_{1.0}B_{5.0}Al_{0.2}Cu_{0.2}Ga_{0.9}Si_{0.2}Zr_{0.2} (wherein Di is a mixture of Nd and Pr in the compositional ratio Nd:Pr=78:22) and strip casting the melt. The alloy ribbon was hydrogenated and then coarsely milled by dehydrogenation treatment, following which 0.20 wt % of stearic acid was added, giving a coarse powder having a mean particle size of about 100 μm. Next, fine milling to a mean particle size of 2.5 μm or less was carried with a jet mill under a stream of nitrogen. The oxygen concentration within the jet mill at this time was controlled to 50 ppm or below.

The resulting fine powder was charged into the mold of a powder-compacting press under a nitrogen atmosphere and, while applying a 15 kOe horizontal static magnetic field, was pressed and compacted in a direction perpendicular to the magnetic field in order to orient the powder. The resulting compact was sintered by heat treatment in a vacuum under the sintering conditions shown in Table 6. The sintered body was cooled to 200° C. or below, after which heating at 900° C. was maintained for 2 hours. The sintered body was cooled in an argon gas atmosphere at a rate of 20° C./min and then low-temperature heat-treated at 470° C. for 2 hours.

A specimen in the shape of a rectangular parallelepiped having dimensions of 18 mm×15 mm×12 mm was cut from the center portion of the resulting sintered body, and the magnetic properties were measured with a BH tracer from Toei Industry Co., Ltd. The measurement temperatures were room temperature (23° C.), and also 50° C., 80° C., 100° C., 110° C. and 130° C. These measured results and the computed β₁, β₂, μ₁ and μ2 values are shown in Tables 7 and 8. In addition, SEM microscopy was carried out on each of the sintered rare-earth magnets in the same way as in Example 1 and the area fraction of the R₂(T, M1)₁₇ phase relative to the overall section was determined, in addition to which the specimen was checked for the absence or presence of abnormal grain growth. The results are shown in Table 6.

TABLE 6

| | Sintering | Sintering | Area fraction | Abnormal |
|---|---|---|---|---|
| | temperature | time | of 2-17 phase* | grain |
| | (° C.) | (hours) | (%) | growth |
| Example 5 | 1,055 | 5 | 3 | no |
| Example 6 | 1,030 | 9 | 5 | no |
| Comparative | 1,050 | 4 | >10 | no |
| Example 2 | | | | |
| Comparative | 1,040 | 3 | >10 | no |
| Example 3 | | | | |
| Comparative | 1,030 | 5 | >10 | no |
| Example 4 | | | | |
| Comparative | 1,030 | 13 | none | no |
| Example 5 | | | | |
| Comparative | 1,070 | 5 | none | yes |
| Example 6 | | | | |

*2-17 phase: R₂(T, M1)₁₇ phase

TABLE 7

| | Temperature | | | | | | | |
|---|---|---|---|---|---|---|---|---|
| | | | Room | | | | | |
| | Room temperature | | temperature | 50° C. | 80° C. | 100° C. | 110° C. | 130° C. |
| | Magnetic properties | | | | | | | |
| | Bᵣ | H_{cJ} | Hₖ₁ (kOe) (top value) | | | | | |
| | (kG) | (kOe) | Hₖ/H_{cJ} (bottom value) | | | | | |
| Example 5 | 12.97 | 22.3 | 14.8 | 12.3 | 10.3 | none | none | none |
| | | | 0.94 | 0.96 | 0.97 | 0.97 | 0.98 | 0.98 |
| Example 6 | 13.00 | 21.9 | 14.5 | 12.4 | 10.2 | none | none | none |
| | | | 0.94 | 0.95 | 0.98 | 0.98 | 0.97 | 0.98 |
| Comparative | 12.99 | 21.6 | 14.8 | 12.9 | 10.0 | none | none | none |
| Example 2 | | | 0.79 | 0.84 | 0.89 | 0.93 | 0.94 | 0.97 |
| Comparative | 13.00 | 20.7 | 14.3 | 14.3 | 12.8 | none | none | none |
| Example 3 | | | 0.69 | 0.74 | 0.80 | 0.84 | 0.86 | 0.91 |
| Comparative | 12.99 | 20.1 | 14.0 | 12.6 | 10.1 | none | none | none |
| Example 4 | | | 0.69 | 0.74 | 0.78 | 0.88 | 0.85 | 0.91 |
| Comparative | 12.97 | 23.0 | none | none | none | none | none | none |
| Example 5 | | | 0.98 | 0.98 | 0.98 | 0.98 | 0.98 | 0.98 |
| Comparative | 12.95 | 22.6 | none | none | none | none | none | none |
| Example 6 | | | 0.96 | 0.96 | 0.96 | 0.95 | 0.95 | 0.95 |

TABLE 8

| | β₁ (%/K) | β₂ (%/K) | μ₁ | μ₂ |
|---|---|---|---|---|
| Example 5 | −0.531 | −0.568 | 1.03 | 1.13 |
| Example 6 | −0.520 | −0.549 | 1.03 | 1.23 |
| Comparative Example 2 | −0.573 | −0.579 | 1.03 | 1.32 |
| Comparative Example 3 | −0.399 | −0.624 | 1.03 | 2.04 |
| Comparative Example 4 | −0.365 | −0.623 | 1.03 | 1.71 |
| Comparative Example 5 | — | −0.560 | — | — |
| Comparative Example 6 | — | −0.560 | — | — |

In the magnets obtained in Comparative Examples 2 to 4, because the sintering times were shorter than the sintering times given by formula (2), precipitation of the R₂(T, M1)₁₇ phase in excess of 10% was observed in sections of the respective resulting sintered magnets (Table 6). As a result, the squareness (Hₖ/H_{cJ}) at room temperature worsened to 0.79 or below; even at high temperature, the squareness did not sufficiently improve (Table 7). In addition, the average relative permeabilities μ₂ between the first knickpoint and the second knickpoint exhibited high values of from 1.32 to 2.04 (Table 8). On the other hand, in the magnets in Comparative Examples 5 and 6, the sintering times were longer than the sintering times given by formula (2), as a result of which precipitation of the R₂(T, M1)₁₇ phase was not observed in sections of the respective resulting sintered magnets (Table 6), and a first knickpoint was not observed at below 90° C. (Table 7). However, in the magnet obtained in Comparative Example 6, the sintering temperature was a relatively high temperature, and so abnormal grain growth was observed after sintering (Table 6). Also, the magnet in Comparative Example 5 had a sintering time in excess of 11 hours, and so the productivity markedly worsened (Table 6).

Japanese Patent Application No. 2023-069056 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A sintered rare-earth magnet comprising R (wherein R is two or more elements selected from rare-earth elements, with Nd and Pr being essential), T (wherein T is one or more element selected from Fe and Co), boron (B), M1 (wherein M1 is one or more element selected from Al, Si, Cr, Mn, Cu, Zn, Ga, Ge, Mo, Sn, W, Pb and Bi) and M2 (wherein M2 is one or more element selected from Ti, V, Zr, Nb, Hf and Ta), with R accounting for 12.5 to 16.0 at %, B for 4.5 to 5.3 at %, M1 for 0.5 to 2.5 at %, M2 for 0.05 to 0.5 at % and the balance being T,
wherein the magnet has a R₂T₁₄B main phase and, over an area fraction of more than 0% and up to 10%, an R₂(T, M1)₁₇ phase covered with an R₆(T, M1)₁₄ phase and an R-rich phase, and
wherein two magnetization inflection points—a first knickpoint on a low magnetic field side and a second knickpoint on a high magnetic field side—are present in a second quadrant of a magnetic polarization curve at 23° C.

2. The sintered rare-earth magnet of claim 1, wherein the magnetic field at the first knickpoint (first knick field Hₖ₁) is 10 kOe or more.

3. The sintered rare-earth magnet of claim 1, wherein the absolute value |β₁| of the temperature change rate of the first knick field Hₖ₁ is smaller than the absolute value |β₂| of the temperature change rate of the magnetic field at the second knickpoint (second knick field Hₖ₂) and satisfies formula (1) below
$$\vert {β}_{1} \vert < \vert {β}_{2} \vert \times 0.94 , \qquad ( 1 )$$
the temperature change rate β₁ of the first knick field Hₖ₁ and the temperature change rate β₂ of the second knick field Hₖ₂ being defined as follows:
$$\begin{matrix}{β}_{1} = ( {H}_{k 1} @ 90 ° C . - {H}_{k 1} @ 23 ° C . ) / ( 90 - 23 ) / ( {H}_{k 1} @ 23 ° C . ) \\ {β}_{2} = ( {H}_{k 2} @ 90 ° C . - {H}_{k 2} @ 23 ° C . ) / ( 90 - 23 ) / ( {H}_{k 2} @ 23 ° C . ) .\end{matrix}$$

4. The sintered rare-earth magnet of claim 1 wherein, in at least the second quadrant of magnetic polarization curves at 90° C. and above, the first knickpoint vanishes.

5. The sintered rare-earth magnet of claim 1 wherein, in the second quadrant of magnetic polarization curves at a temperature range above 23° C. and below 90° C., the first knick field Hₖ₁ is 8 kOe or more.

6. The sintered rare-earth magnet of claim 1 wherein, in the magnetic polarization curve at 23° C., an average relative permeability μ₂ between the first knick field Hₖ₁ and the second knick field Hₖ₂ is larger than 1.1 and smaller than 1.3.

7. The sintered rare-earth magnet of claim 1 wherein, in a magnetic polarization curve at any temperature, an average relative permeability μ₁ at a magnetic field lower than the first knick field Hₖ₁ is at least 1.0 and not more than 1.05.

8. A method for producing the sintered rare-earth magnet of claim 1, comprising a heat treatment step that sinters a compact obtained by pressing a fine powder of a starting alloy within a magnetic field, in which heat treatment step the sintering temperature T is at least 1,020° C. and not more than 1,080° C. and the sintering time t, given by formula (2) below
$$t = 200.45 \pm 1 - 0.185 T , \qquad ( 2 )$$
is 1 hour or more and less than 11 hours.
